(19) United States
(12) Patent Application Publication
(10) Pub. No.: US 2018/0152045 A1
(43) Pub. Date: May 31, 2018

(54) MODULAR AND SCALABLE CAPACITOR STORAGE ARRAY POWER SYSTEM

(71) Applicant: David B. Lattibeaudiere, Leesburg, VA (US)

(72) Inventor: David B. Lattibeaudiere, Leesburg, VA (US)

(21) Appl. No.: 15/364,940

(22) Filed: Nov. 30, 2016

(51) Int. Cl. H02J 7/35; H02S 40/36; H02J 7/00

(52) U.S. Cl. CPC H02J 7/355; H02J 7/345; H02J 7/0068; H02S 40/36

(57) ABSTRACT

A power system using capacitor arrays for storing the light energy as electricity is provided. The power system uses all solid-state materials for providing modularity and scalability. The power system provides solar cells arrays or alternative power sources coupled to a solid-state electrical capacitor array via a solid-state bus, wherein solid state programmable charging and discharging switch modules regulate current.

### BACKGROUND OF THE INVENTION

The present invention relates to power systems and, more particularly, to a power system for capturing and storing energy as electricity in a capacitor array device.

Current light, or other energy capture and storage systems, use devices that are not modular, portable or scalable because they do not utilize all solid-state materials. Furthermore, such systems do not store electricity efficiently as electricity generated is typically stored in battery systems.

Additionally, current battery technologies leave a large (polluting) eco-system footprint frequently creating harmful health and environmental issues, threatening the future of electrical vehicle, and other industries; see recent reports of graphite-dust pollution in Northeast China.

As can be seen, there is a need for an environmentally-friendly power system using diverse sources for capturing electrical energy and using capacitor arrays for storing the generated energy wherein the system uses all solid-state materials for providing modularity, scalability, and ease of manufacturing

### SUMMARY OF THE INVENTION

In one version of the present invention, a power system includes a plurality of solar cells array configured to convert light energy to electricity; a solid-state bus; and a solid-state electrical capacitor array coupled to the plurality of solar cells array via the solid-state bus, wherein the solid-state electrical capacitor array is configured to store said electricity.

In other flavors of the present invention, the power system uses other forms of energy (mechanical/kinetic/wind) to generate electricity via the solid-state bus to the solid-state electrical capacitor array. Via the solid-state bus, wherein the solid-state electrical capacitor array is configured to store said electricity; a solid state programmable charging switch module serially connecting the plurality of solar cells array or other electricity generators with the solid-state bus; and a solid state programmable discharging switch module serially coupling an output of the solid-state electrical capacitor array to an external interface, wherein the solid-state electrical capacitor array is be configured to pull power from the solid-state bus when the solid state programmable discharging switch module is activated.

In yet another aspect of the present invention, the power system includes alternative power sources, a solid-state bus, a solid-state electrical capacitor array coupled to the power source via the solid-state bus; wherein the solid-state electrical capacitor array is configured to store said electricity; a solid state programmable charging switch module serially connects the power source and the solid-state bus; and a solid state programmable discharging switch module serially coupling an output of the solid-state electrical capacitor array to an external interface, wherein the solid-state electrical capacitor array is be configured to pull power from the solid-state bus when the solid state programmable discharging switch module is activated.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a power system using capacitor arrays for storing electricity, wherein the system uses all solid-state materials for providing modularity and scalability. The power system provides solar cells arrays or alternative power sources coupled to a solid-state electrical capacitor array via a solid-state bus, wherein solid state programmable charging and discharging switch modules regulate current to charge the capacitor array or to discharge/supply required electricity to application/device.

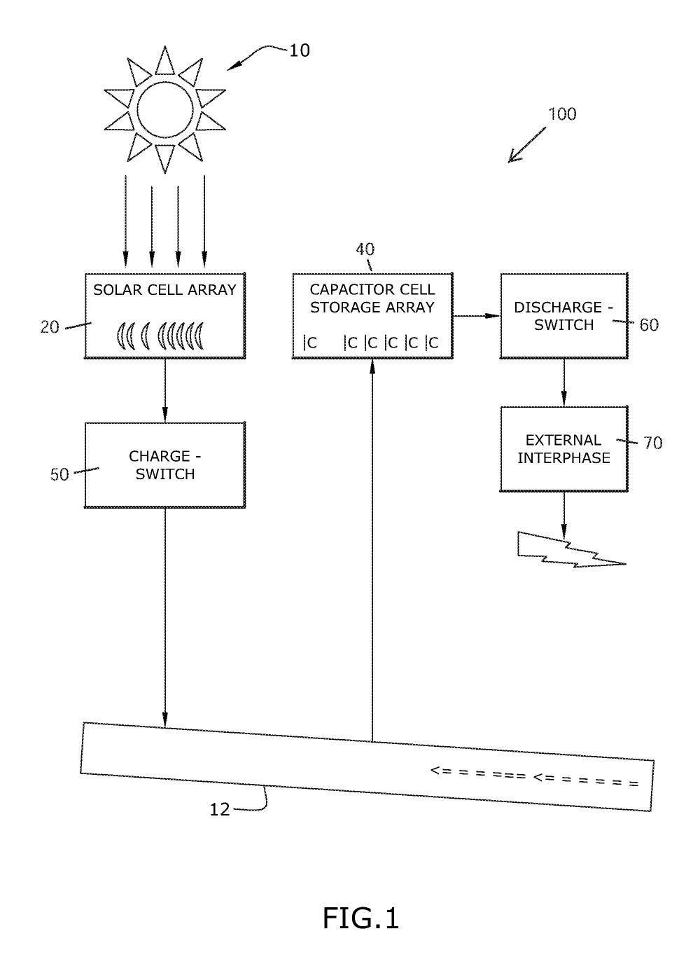

Referring to FIG. 1, the present invention may include a power system 100 embodying solar cells arrays 20 or an alternative power source coupled to a solid-state electrical capacitor array 40 via a solid-state bus 12. A solid state programmable charging switch module 50 may interconnect the solar cell arrays 20/alternative power source and the solid-state bus 12, and a solid state programmable discharging switch module 60 may be coupled to the output of the solid-state electrical capacitor array 40.

In charging mode, the solar cells arrays 20 may be configured to capture light energy from a light source 10 and convert it to electricity, or in certain embodiments alternative power sources may provide electricity, wherein the electricity is sent to the solid-state bus 12. The solid-state bus 12, in turn, connects the output of the solar cells arrays 20/alternative power source to the inputs of the solid-state electrical capacitor array 40. The solid-state electrical capacitor array 40 may be configured to pull power from the solid-state bus 12, interconnecting it to an external interface port 70, load component or the like, when in discharge mode. The charging and discharging modules 50 and 60 may be connected in series to provide required EMF then switched on to supply electricity to power systems.

A method of using the present invention may include the following. The power system 100 disclosed above may be provided so that if light from the light source 10 or an alternative power source is available, and the charging switch module 50 is in charging mode, the electricity generated from the solar cells arrays 20/alternative power source may be routed via the solid-state bus 12 to the solid-state electrical capacitor array 40. If the charging switch module 50 is off and discharging switch module 60 is activated, stored electricity is routed from the solid-state electrical capacitor array 40 via the solid-state bus 12 to the external interface port 70, and most likely to a load component.

It should be understood, of course, that the foregoing relates to exemplary embodiments of the invention and that modifications may be made without departing from the spirit and scope of the invention as set forth in the following claims.

What is claimed is:

1. A power system, comprising:
a plurality of solar cells arrays configured to convert light energy to electricity;
a solid-state bus; and
a solid-state electrical capacitor array coupled to the plurality of solar cells arrays via the solid-state bus, wherein the solid-state electrical capacitor array is configured to store said electricity.

2. The power system of claim 1, further comprising a solid state programmable charging switch module interconnecting the plurality of solar cells arrays and the solid-state bus.

3. The power system of claim 1, further comprising a solid state programmable discharging switch module coupled to an output of the solid-state electrical capacitor array.

4. The power system of claim 3, further comprising an external interface coupled to the solid state programmable discharging switch module.

5. The power system of claim 3, wherein the solid-state electrical capacitor array is be configured to pull power from the solid-state bus when the solid state programmable discharging switch module is activated.

6. The power system of claim 2, wherein the solid state programmable charging switch is connected in series.

7. The power system of claim 3, wherein the solid state programmable discharging switch is connected in series.

8. A power system, comprising:
a plurality of solar cells arrays configured to convert light energy to electricity;
a solid-state bus;
a solid-state electrical capacitor array coupled to the plurality of solar cells arrays via the solid-state bus, wherein the solid-state electrical capacitor array is configured to store said electricity;
a solid state programmable charging switch module serially connecting the plurality of solar cells arrays and the solid-state bus; and
a solid state programmable discharging switch module serially coupling an output of the solid-state electrical capacitor array to an external interface, wherein the solid-state electrical capacitor array is be configured to pull power from the solid-state bus when the solid state programmable discharging switch module is activated.

9. A power system, comprising:
a power source;
a solid-state bus;
a solid-state electrical capacitor array coupled to the power source via the solid-state bus, wherein the solid-state electrical capacitor array is configured to store said electricity;
a solid state programmable charging switch module serially connecting the power source and the solid-state bus; and
a solid state programmable discharging switch module serially coupling an output of the solid-state electrical capacitor array to an external interface, wherein the solid-state electrical capacitor array is configured to pull power from the solid-state bus when the solid state programmable discharging switch module is activated.
